(19) United States
(12) Patent Application Publication
(10) Pub. No.: US 2003/0165123 A1
(43) Pub. Date: Sep. 4, 2003

(54) Channel allocation and assignment methods and systems

(76) Inventors: Simon Reza Saunders, Surrey (GB); Mauro Fiacco, Hertfordshire (GB)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/311,577

(22) PCT Filed: Jun. 20, 2001
(86) PCT No.: PCT/GB01/02727

(51) Int. Cl. H04Q 7/00

(52) U.S. Cl. 370/329; 370/332

(57) ABSTRACT

A channel allocation and assignment method and system in which users are prioritised for channel allocation according to the mean SINR on their current channels. A channel is assigned to a user if the SINR on that channel exceeds a threshold value.

This invention relates to channel allocation and assignment methods and systems for use in cellular communications systems, particularly though not exclusively, cellular communication systems employing adaptive antenna systems.

The use of hand-held cellular phones has increased rapidly in the last few years. Moreover, the needs of users constantly being connected to their e-mail and other online services will lead to the creation of a “Wireless Office” (see, for example, “Wireless LAN”, Nokia at http://www.nokia. com/corporate/wlan/woffice.html and “PicoNode”, Nortel at http://www.nortelnetworks.com/products/01/gsmlpn.html), where different appliances (phones, computers, palm tops etc.) will make use of radio spectrum for communicating in the indoor environment. This will necessitate improved in-building coverage and traffic capacity by the introduction of indoor picocell and dedicated wireless indoor systems.

One technology that is employed in order to increase radio spectrum efficiency is Dynamic Channel Allocation (DCA). As described in “Channel assignment scheme for cellular mobile telecommunication systems: A comprehensive survey” by I Katzela, M Naghshineh, IEEE Personal Communications, pages 10-31, June 1996, DCA makes use of the radio propagation characteristics in order to minimise the signal to interference plus noise ratio (SINR).

The present invention provides a channel allocation and assignment method and system particularly, though not exclusively, suited to operate in an adaptive distributed antenna environment. It is envisaged that the proposed method and system will greatly increase capacity and coverage in the indoor environment.

According to one aspect of the invention there is provided a channel allocation and assignment method for use in a cellular communications system, wherein channel allocation and channel assignment are carried out in dependence on a measure of signal quality.

According to another aspect of the invention there is provided a channel allocation and assignment system for carrying out the method of said one aspect of the invention.

Channel allocation and assignment methods and systems according to the invention have the capability to operate in any cellular communications system which can employ Dynamic Channel Allocation, where the channel can be defined in terms of time, frequency or code, including: DECT, GSM, DCS, IS95, UMTS or any other cellular scheme. The method and system can also operate with any access scheme, including TDMA, CDMA or OFDMA.

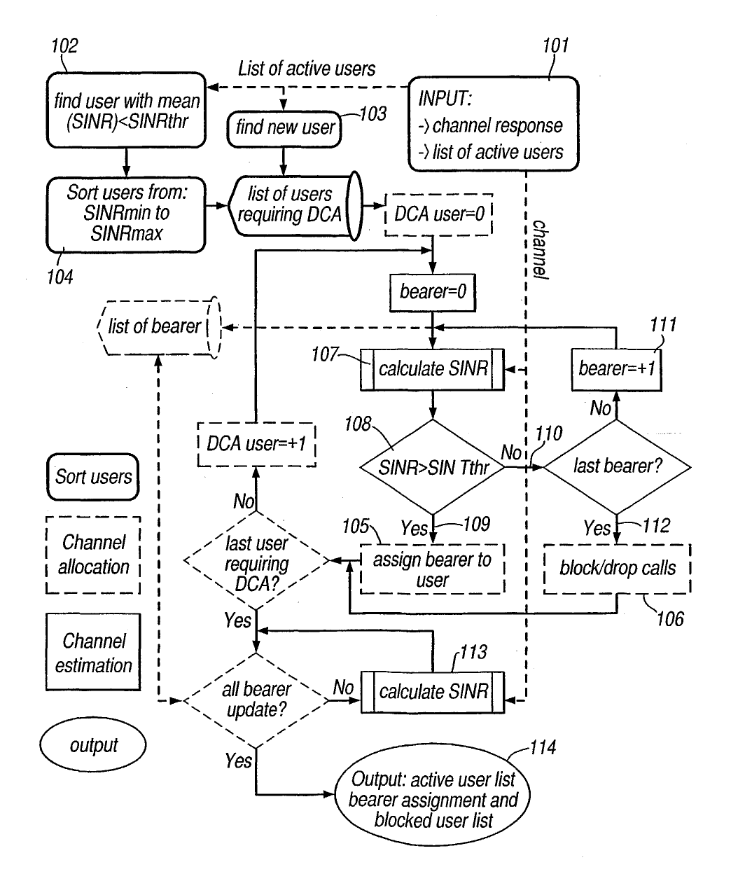

Embodiments of the invention are now described, by way of example only, with reference to the accompanying drawing (FIG. 1) which shows a flow diagram representing an algorithm for implementing a channel allocation and assignment method and system according to the invention.

In the described embodiment, the DCA scheme was developed to operate in systems which employ the Space Division Multiple Access (SDMA) technique. SDMA enhances the capacity of a cellular system by exploiting the spatial separation between users. In SDMA systems, multiple applications of antenna combiner are used to optimise the performance with respect to each mobile, which allows interference signals and source signals to coexist inside the same geographical area, as described, for example, in “Antennas and Propagation for Wireless Communication Systems” by S. Saunders, Wiley, 1999. Because the system capacity and coverage follows the mobile as it moves within the building, the conventional concept of a user residing in a fixed cell is lost. In accordance with the invention, channel allocation is carried out only on the statistics of the signal quality (eg SINR, BER), and not on the specific position (cell) of the user. This type of “soft handover” between channel bearers allows the system to select a bearer from a pool of channels, each of which can be assigned to any user, producing higher spectral efficiency and greater capacity.

The proposed scheme employs information on the radio channel between users and base station collected by the receiver, and a list of active users generated by the system call management layer. These input data are used to prioritise the users which need to handover to another bearer channel and to check whether a new bearer channel is suitable in terms of SINR level. When a new bearer channel has been found, the user is assigned to it. The output of the scheme is a list of active users and bearer assignments, producing calls with minimal blocking and dropping probability in the case of circuit-switched calls, or maximum throughput in the case of packet-switched data.

The algorithm represented by FIG. 1 performs three interlaced processes; namely “user sorting” represented by the thick line function boxes, ‘channel allocation’ represented by the broken line function boxes and ‘channel estimation’ represented by the thin line junction boxes. Each of these processes is now described in turn. User sorting: (thick black line) sorts the list of active users stored in input (101) into users requiring channel allocation (102) (users changing bearers) and users requiring channel assignment (103) (new users trying to access the system). An existing user will be identified as requiring channel allocation if the user's mean SINR is less than a threshold value SINRₜₕᵣ. In this scheme, channel allocation takes priority over channel assignment because, from the point of view of a user, a dropped call has a more negative impact than a blocked call on overall network quality of service. In order to sort the users requiring channel allocation the following schemes are proposed.

The users identified as requiring channel allocation are arranged in order of lowest mean SINR (SINRₘᵢₙ) to highest mean SINR (SINRₘₐₓ) (104) and the highest priority is given to users with the worst (i.e. lower) mean SINR. This is because, in an indoor environment where SDMA is employed, a low SINR may indicate that the distance between users is too small to be resolved by the adaptive antenna system. Therefore, by removing the worst user from a particular channel bearer it is likely that other users might benefit from the new interference situation, and therefore may not need reallocation.

In order to accommodate the needs of users requiring access to a range of different services, the scheme can be further developed. Some applications will require lower error rates, and hence a higher SINR. Also, it may be undesirable for the system to place a high priority on some calls due to the excessive system resources which would be required to serve such calls. In such situations users may be sorted according to the following metric:

$${SINR}_{met} = \frac{{SINR}_{thr}}{SINR} \cdot priority$$

where SINR is current SINR, SINRₜₕᵣ is the threshold SINR for the corresponding service, and “priority” is a number between 0 and 1, chosen to reflect the value to the operator of carrying the service.

The algorithm decides which user needs to handover to a different channel based on the running local mean of past SINR samples (102). The number of SINR samples is set comparable to the shadowing correlation distance of the signal, thereby avoiding excessive numbers of channel reassignments. A new user does not require channel reallocation until enough samples have been stored.

Channel allocation: (broken line) this process checks the channels until a channel with SINR higher than a threshold is found. The channels can be searched sequentially from the first channel until a “good enough” channel has been found (105). If no suitable channel is found the call is dropped or blocked (106).

Alternative search methods include:

An exhaustive search from the first to the last channel, the channel with highest SINR always being allocated to the mobile.

Non-idle channels are checked first. This can give advantages as the interference reduction is carried out by the SDMA scheme, and free channels can be kept available for quick assignment of new users.

Sequentially in a ranked order, where each channel is ranked depending on past SINR measurements.

From the point of view of the channel allocation process, channel allocation and channel assignment are treated in the same way.

Channel estimation: (thin line) the SINR of each user on a channel bearer is calculated (107) and compared (108) with a threshold value or with the SINR metric defined earlier. If the SINR value is greater than the threshold (109), the channel is assigned to the user, otherwise (110) the suitability of another channel (111) is tested. If a user was unsuccessfully tested on all the channels (112) the call will be dropped.

The SINR of every active user is updated (113) every time the algorithm tests a bearer channel for allocating a user. In the case a channel that has not been updated, the algorithm will calculate the SINR of the remaining users.

The output (114) of the DCA scheme is a list of dropped and blocked users and this information can be used in the call management layer of the cellular system.

The SINR threshold SINRₜₕᵣ is a value which depends on different parameters, many of which cannot be accurately defined. Therefore, in this scheme, the specific value of SINₜₕᵣ is calculated from the final bit error rate (BER) statistics measured at the output of the decoder. Updates are made to the threshold value according to the observed relationship between BER and SINR for a given user and service.

1. A channel allocation and assignment method for use in a cellular communications system, wherein channel allocation and channel assignment are carried out in dependence on a measure of signal quality.

2. A method as claimed in claim 1 wherein said measure of signal quality is a measure of signal to interference plus noise ratio (SINR).

3. A method as claimed in claim 2 wherein a system user is identified as requiring channel allocation if a measure of SINR on the user's current channel is less than a threshold (SINRₜₕᵣ).

4. A method as claimed in any one of claims 1 to 3 wherein system users are prioritised for channel allocation according to a measure of signal quality on their current channels.

5. A method as claimed in claim 4 wherein system users are prioritised for channel allocation according to a metric SINRₘₑₜ, given by the expression:
$${SINR}_{met} = \frac{{SINR}_{thr}}{SNIR} \cdot priority$$
where SINRₜₕᵣ is a threshold SINR, SINR is a measure of the SINR on the current channel and priority is a priority value in the range 0 to 1.

6 A method as claimed in any one of claims 1 to 5 wherein channel allocation takes priority over channel assignment.

7. A method as claimed in any one of claims 1 to 6 wherein a channel is allocated or assigned to a user provided a measure of signal quality on the allocated or assigned channel exceeds a threshold value.

8. A method as claimed in claim 3 or claim 5 wherein said threshold SINRₜₕᵣ is related to bit error rate (BER) statistics.

9. A method as claimed in claim 3 wherein said measure of SINR is a mean of past SINR samples on the user's channel.

10. A channel allocation and assignment system for carrying out the method according to any one of claims 1 to 9.

11. A channel allocation and assignment method substantially as herein described with the reference to the drawing.

12. A channel allocation and assignment method substantially as herein described with reference to the drawing.
